(19) United States
(12) Patent Application Publication
(10) Pub. No.: US 2003/0227409 A1
(43) Pub. Date: Dec. 11, 2003

(54) Antenna pointing method and device

(76) Inventor: Gerard Auger, Champagne S.Oise (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/314,413

(22) Filed: Dec. 9, 2002

(30) Foreign Application Priority Data
Dec. 11, 2001 (FR) 01 15988

(51) Int. Cl. H01Q 3/00; H04B 7/00

(52) U.S. Cl. 342/359; 342/367

(57) ABSTRACT

Method and antenna system used to point at least an antenna with respect to one or more other antennas, one of the antennas being a transmission antenna with an opening beam θₑ associated with a rotation speed Rₑ, to cover an angular sector Sₑ transmitting a signal every T_{b} seconds and another antenna being a reception antenna with an opening beam θᵣ associated with a rotation speed Rᵣ to cover an angular sector Sᵣ, comprising at least the following steps

select the parameters

θᵣ/Rᵣ>T_{b},

θₑ/Rₑ>T_{b},

Rᵣ greater than Rₑ or Rₑ greater than Rᵣ

determine the maximum power representative of the best antenna reception for various positions of the transmission antenna or of the reception antenna, and

deduce the optimum positioning angular value of the transmission antenna with respect to the reception antenna.

FIG. 5 to be published

This invention concerns a method and a device which can be used in notably for the relative positioning of antennas.

It is used, for example, to point an antenna of a reception station or of a reception and transmission station to a transmission station or a transmission and reception station.

Its application concerns systems operating in the field of frequencies greater than or equal to at least several gigahertz, in the 4.4-5 GHz and 40 GHz frequency bands and also in high speed systems for example of the order of 10 to 50 Mbits/s.

It applies to antennas with electronic or mechanical pointing, for stations equipped with a transmission antenna and a reception antenna, or possibly a transmission antenna or a reception antenna, or possibly a transmission-reception antenna.

The prior art discloses various systems implementing devices to point the antenna of a reception station or of a reception and transmission station, to a transmission or transmission and reception station.

The known devices are generally “dissymmetric”, i.e. not all stations are identical, one can be fixed and the others steerable. Amongst the dissymmetric devices, the most well known are probably those used to point the antenna of a ground station to a communication satellite.

Other systems include one or more omnidirectional antennas used for example during the initialization phase. The latter type can transmit or receive initialization signals to point the directional antennas which will be used to transfer information and to calculate their optimum position. However, such antennas have certain disadvantages. For example, they may have insufficient gain in some operating conditions. In addition, they are larger.

In the remainder of the description, the expression “antenna beam rotation speed” is used irrespective of the antenna type to designate, for example, a mechanical rotation speed for antennas mounted on mechanical supports, a switching speed of the columns or of the groups of patch columns activated to form the beam for electronically-scanned antennas.

The invention concerns a method to position at least an antenna with respect to one or more other antennas, one of the antennas being a transmission antenna AE with an opening beam θₑ associated with a rotation speed Rₑ, to cover an angular sector Sₑ transmitting a signal every T_{b} seconds and another reception antenna AR with an opening beam θᵣ associated with a rotation speed Rᵣ to cover an angular sector Sᵣ, wherein it comprises at least the following steps:

select the parameters θₑ, θᵣ, Rᵣ, Rₑ, such that:

θᵣ/Rᵣ>T_{b},

θₑ/Rₑ>T_{b},

Rᵣ greater than Rₑ or Rₑ greater than Rᵣ

determine at least a parameter representative of the best antenna reception for various positions of the transmission antenna or of the reception antenna, and

deduce the optimum positioning value of the reception antenna with respect to the transmission antenna or of the transmission antenna with respect to the reception antenna.

The parameter representative of the best antenna reception is for example the maximum received power.

The parameters θₑ, θᵣ, Rᵣ, Rₑ, can be chosen to satisfy at least one of the following relations:

θᵣ/Rᵣ≧Sₑ/Rₑ or

θₑ/Rₑ≧Sᵣ/Rᵣ

The beacon signal transmitted includes for example a parameter used to identify a station equipped with the transmission antenna.

The invention also concerns a system to position an antenna with respect to another antenna comprising at least a transmission antenna with an opening beam θₑ associated with a rotation speed Rₑ, to cover an angular sector Sₑ, the transmission antenna transmitting a signal every Tb seconds and a reception antenna with an opening beam θᵣ associated with a rotation speed Rᵣ to cover an angular sector Sᵣ, said antennas being linked with a device designed to vary the beam rotation speeds, wherein it comprises at least:

a device connected to the transmission antenna and designed to generate a transmission signal,

a device designed to acquire the various signals received by the reception antenna and to process the data to deduce the optimum positioning coordinates of the two antennas with respect to each other.

a device to manage the rotation speed parameters of the beams, such that:

θᵣ/Rᵣ≧T_{b},

θₑ/Rₑ≧T_{b},

Rᵣ is greater than Rₑ or Rₑ is greater than Rᵣ.

This invention offers in particular the following advantages:

all stations have the same equipment and implement identical or nearly identical procedures to initialize the antenna pointing,

it is now possible to set up a link between any two stations in an ad hoc (term known by those skilled in the art) network,

since there are no omnidirectional antennas, the risks of jamming or obstruction by interference are minimized and it is not necessary to use a special transmission mode to compensate the resulting gain loss.

Other advantages and features of the invention will be clearer on reading the following description given as a non-limiting example, with reference to figures representing in:

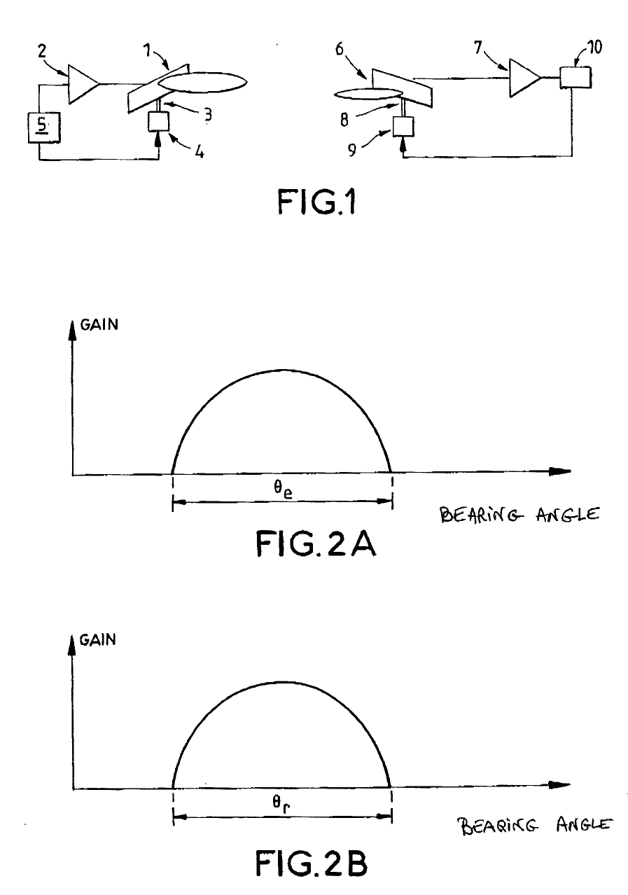

FIG. 1, a block diagram of an example of a device according to the invention, comprising a transmission antenna and a reception antenna, each equipping two separate stations,

FIGS. 2A and 2B respectively, the openings of the transmission and reception antenna lobes,

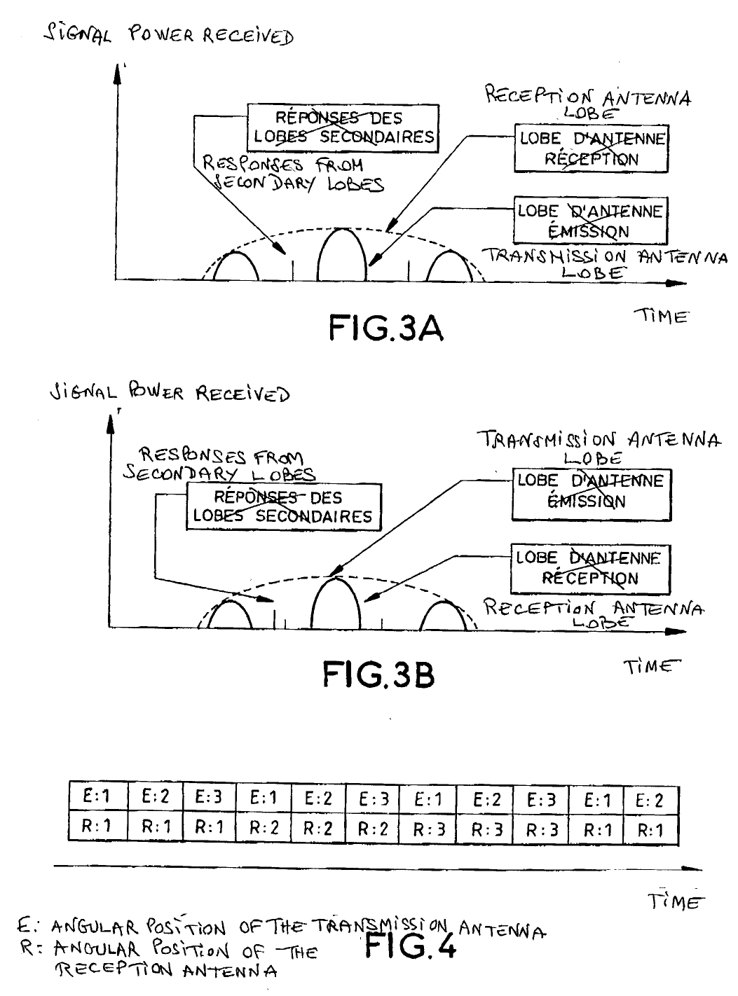

FIGS. 3A and 3B, the response output from the receiver of the reception antenna respectively for Rᵣ>Rₑ and Rₑ>Rᵣ,

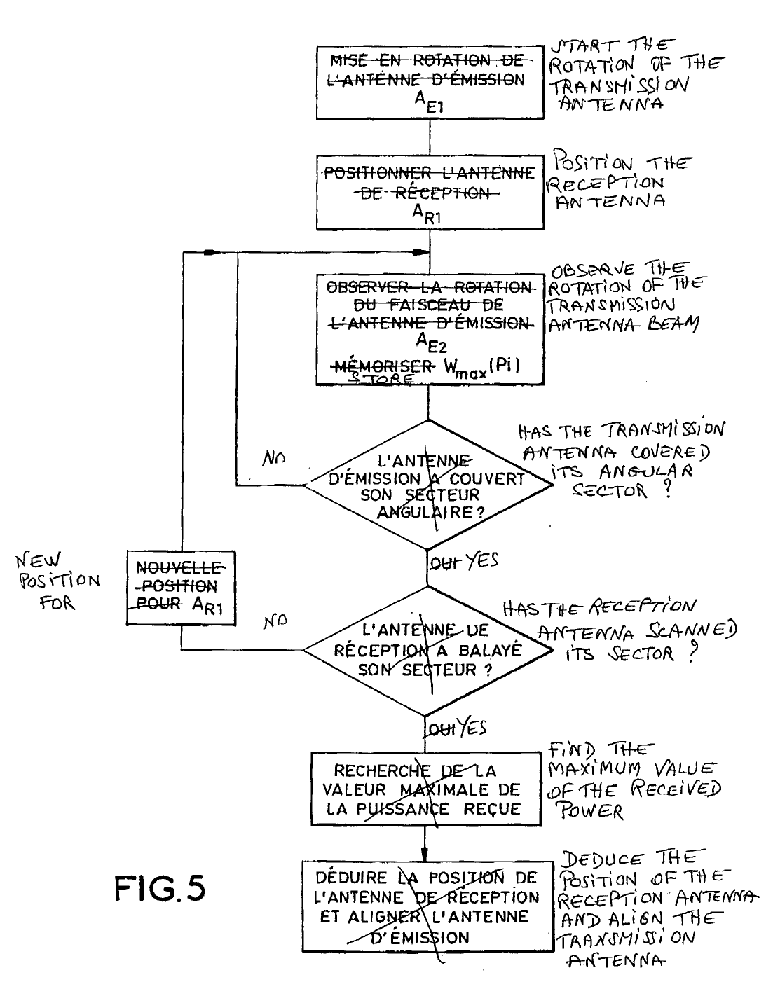

FIG. 4, an example of time synchronization using a frame,

FIG. 5, a flowchart showing the various steps implemented in the method, and

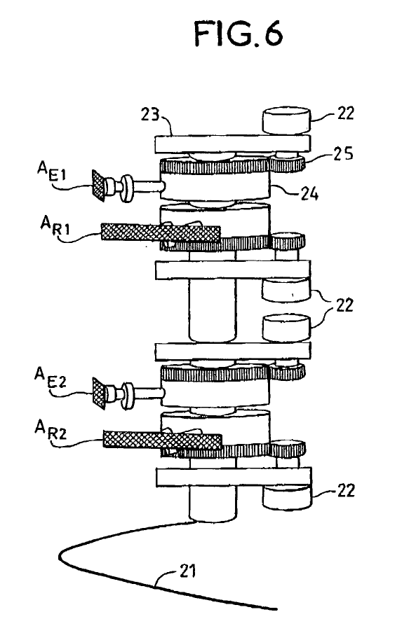

FIG. 6, an example of an antenna system comprising several stacked antennas.

To provide a better understanding of the principle implemented in the invention, the following description given as a non-limiting example concerns a radiocommunication system comprising a first station equipped with a transmission antenna A_{E1} and a reception antenna A_{R1} and a second station equipped with the same or similar equipment.

On FIG. 1, a transmission antenna 1 linked to a transmitter 2 is mounted on a mechanical support 3 connected to a motor 4 used to rotate it for example in a horizontal plane. This antenna, with a horizontal opening beam θₑ in bearing (FIG. 2A), can rotate at a speed equal to Rₑ rad/s in the horizontal plane. A microprocessor 5 is used in particular to control the motor 4 and also to generate a signal, for example a recurrence beacon Tb.

The reception antenna 6 associated with a receiver 7 is itself mounted on a mechanical support 8 allowing it to be rotated by a motor 9 in a horizontal or nearly horizontal plane. The reception antenna beam is a beam with horizontal opening θᵣ rd in bearing (FIG. 2B). This beam can rotate in the horizontal plane with a speed equal to Rᵣ rad/s. A microprocessor 10 receives the information from the receiver 7, notably the power of the received signal. It also checks the speed of rotation of the motor 9 and its positions. During the rotation of the reception antenna, the microprocessor 10 determines, for example, the best reception position. The microprocessor is also designed to transmit some commands to the motor, such as the command to find the best position. Several techniques can be considered.

The motor could be a stepping motor and the antenna positions could be identified by the number of steps made from a reference position.

The motor could be a continuous motor supplied with constant or nearly constant current. The motor therefore turns at constant speed and the antenna positions are identified, for example, by using the time elapsed from a reference time.

The antenna rotation movement is, for example, continuous and in the same direction. It covers, for example, an angular sector in which the stations to be contacted are explored alternately in the forward direction and in the backward direction. This is used, in particular, to fully scan angular sectors equal respectively to Sₑ rad and Sᵣ rad, avoid damaging the connecting wires or complicating the assembly due to the presence of rotating joints. The angular sector explored is greater than or equal to 360°, to avoid having to specify the directions where the stations to be contacted are seen.

For an electronically-scanned antenna, the rotation speed is produced for example using a network of dephasers controlled electronically according to the direction required for the beams, using principles known by those skilled in the art.

The visibility time tᵥ of a second station from a station equipped with an antenna of beam width equal to θ rad and moving at a rotation speed of R rad/s is equal to θ/R seconds.

According to one mode of realization of the method, all stations are identically equipped with a transmission antenna of beam width θₑ moving at a rotation speed of Rₑ and a reception antenna of beam width θᵣ moving at a rotation speed of Rᵣ. A second remote station therefore remains visible to a first station:

By its reception antenna for a time tᵣ equal to tᵣ=θᵣ/Rᵣ expressed in seconds for example,

By its transmission antenna for a time tₑ equal to tₑ=θₑ/Rₑ s.

So that a first station can receive a recurrence beacon T_{b} (s) from a second station, the transmission antenna of the second station must be visible by the first station and the reception antenna of the first station must be visible by the second station simultaneously. The following relations must therefore be satisfied:

Condition 1

tᵣ=θᵣ/Rᵣ>T_{b} (1)

tₑ=θₑ/Rₑ>T_{b} (2)

Condition 2

The direction at which an another station is seen lies within the angular sectors of the beams Sₑ and Sᵣ, which can also be expressed as follows:

Sₑ≧2π and Sᵣ≧2π (3)

Condition 3

The rotation speed of one of the antennas must be less than the rotation speed of the other antenna, which results in the following:

If the reception antenna rotates more slowly than the transmission antenna: the transmission antenna must for example have scanned its entire sector whilst it is illuminated by the reception antenna of another station, a beacon being received if:

θᵣ/Rᵣ≧Sₑ/Rₑ (4)

FIG. 3A represents the response output from the receiver or the power of the received signal if the transmission antenna rotates more quickly than the reception antenna.

When the transmission antenna rotates more slowly than the reception antenna, the reception antenna must for example have scanned its entire sector whilst it is illuminated by the transmission antenna of another station.

θₑ/Rₑ≧Sᵣ/Rᵣ (5)

FIG. 3B represents the power of the received signal when the reception antenna rotates more quickly than the transmission antenna.

The angular sectors Sₑ and Sᵣ of a station cover the direction in which the stations that the links are to be set up with are seen. Consequently, after a maximum time equal to Sᵣ/Rᵣ or Sₑ/Rₑ, each station will have been able to receive at least one beacon from stations within radioelectric range.

In particular, the positions of the antenna beams are, for example, synchronized on a time frame as described on FIG. 4. This frame defines, at every instant, a pair (E, R) of angular positions for the transmission antennas and for the reception antennas. This guarantees that for each possible position of the transmission antenna, the reception antenna has been simultaneously placed in all its possible positions. In addition, at least one beacon signal must be transmitted in each time slot of duration t_{f}, which is easy to achieve, in particular, if t_{f}=T_{b}. t_{f} is the duration during which the beam of an antenna is held at the same position.

These conditions, given for transmission antennas and reception antennas located in separate stations, remain applicable for transmission antennas and reception antennas located in the same station. They also remain applicable for antennas with both transmission and reception functions.

They apply to all types of antenna, including electronically-scanned antennas, irrespective of the station layout.

If the transmission antenna rotates more quickly than the reception antenna Rₑ>Rᵣ, the method according to the invention includes, for example, the steps described in relation with FIG. 5:

a) the microprocessor of a first station sends a control signal to the motor connected to its transmission antenna A_{E1} to transmit a rotation speed, Rₑ,

b) the same microprocessor positions the reception antenna A_{R1} of the first station in a given position Pi,

c) during the scanning of the transmission antenna A_{E2} of a second station, the microprocessor, for example that equipping the first station, stores the maximum value of the power received Wmax(Pi) on the antenna A_{R1}, for position Pi,

d) once the transmission antenna A_{E2} of the second station has scanned all or most of its angular sector Sₑ, the microprocessor sends a control signal to the reception antenna A_{R1} of the first station to move it to another position and the method repeats step b) and c) until the reception antenna A_{R1} has completely scanned its angular sector Sᵣ or virtually all of this angular sector.

After steps a) to d), the microprocessor associated with the reception antenna of the first station and/or the microprocessor associated with the reception antenna of the second station has the maximum power values determined for several positions of the reception antenna A_{R1} or A_{R2}.

e) it then determines, using for example a method to find the maximum, the maximum value Wmax of the received power.

f) From this maximum value Wmax, it deduces the optimum position for the reception antenna A_{R1}, respectively the position for the reception antenna A_{R2} and positions it on this value.

g) The transmission antenna A_{E1} or A_{E2} is then aligned on the reception antenna A_{R1} or A_{R2}.

Step d) can be completed by a processing step such as filtering designed to reduce or eliminate noise.

The algorithm used to find the maximum power is, for example, designed to detect the various local maxima of the transmission and reception antennas which correspond to the main lobe and the various secondary lobes and to keep the maximum value. Consequently, the sector of the reception antenna beam of a station is scanned, either completely or almost completely, avoiding the positions where the beacon is received by the secondary lobes.

According to a realization variant, the signal transmitted by the transmission antenna includes, for example, an indicator of the transmitting station, the value of the pointing angle for a given instant, the value of the transmission angle of a remote station offering the best local reception.

The station indicator enables, for example, a remote station to select the station(s) with which it wants to set up a link.

The value of the transmission beam angle θₑ at the time when the beacon T_{b} is transmitted enables, for example, a remote station to control the positioning or possibly stop the transmission antenna on the best position.

The parameter representative of the best position of one antenna with respect to the other is, for example, the pointing angle. The pointing angle can be measured with respect to any reference. The reference is, for example, identified with respect to a position of the stepping motor or to a position of the continuous motor depending on the type of motor used.

FIG. 4 is a diagrammatic representation of a realization variant 20 where the transmission and reception antenna beams can each take 3 discrete positions. Consequently, if each station has the same reference time, the angular positions of the transmission and/or reception antennas can be designated and identified by the time slot number of the reference frame.

The stations can exchange information, for example communicate the angular positions corresponding to the maximum power.

FIG. 6 represents an example of antenna system designed to equip a station comprising several transmission and reception antenna pairs (A_{Ei}, A_{Ri}) designed to set up several simultaneous links (two links L₁ and L₂ on the figure). The pointing of the antennas of each pair is carried out according to the principle of the invention. Mounting is carried out, for example, around a fixed column 20 hollow inside so that cables 21 powering and controlling the antennas and the motors 22 can be fed through. A motor 22 is for example associated with an antenna. The motors 22 are attached, for example, on trays 23 fixed to the central column 20. The transmission and reception antennas are mounted on rings 24 which can rotate around the central column 20 and which are driven by the motors via gears 25. The following are associated with each transmission-reception antenna pair:

a device designed to generate a transmission signal and connected to the transmission antenna,

a device designed to acquire the various signals received by the reception antenna and to process the data to deduce the optimum positioning coordinates of the two antennas with respect to each other.

a device to manage the rotation speed parameters of the beams, such that:

θᵣ/Rᵣ≧T_{b},

θₑ/Rₑ≧T_{b},

Rᵣ is greater than Rₑ or Rₑ is greater than Rᵣ.

a device to align the antennas associated with each link.

1- Method to point at least an antenna with respect to one or more other antennas, one of the antennas being a transmission antenna A_{E} with an opening beam θₑ associated with a rotation speed Rₑ, to cover an angular sector Sₑ transmitting a signal every T_{b} seconds and another antenna being a reception antenna A_{R} with an opening beam θᵣ associated with a rotation speed Rᵣ to cover an angular sector Sᵣ, wherein it comprises at least the following steps
select the parameters θₑ, θᵣ, Rᵣ, Rₑ, such that:
θᵣ/Rᵣ≧T_{b},
θₑ/Rₑ≧T_{b},
Rᵣ greater than Rₑ or Rₑ greater than Rᵣ
determine at least a parameter representative of the best antenna reception for various positions of the transmission antenna or of the reception antenna, and
deduce the optimum positioning value of the reception antenna with respect to the transmission antenna or of the transmission antenna with respect to the reception antenna.

2- method according to claim 1, wherein the parameter representative of the best reception is the received power, preferably the maximum power.

3- Method according to claim 1, wherein the following is chosen:
θᵣ/Rᵣ≧Sₑ/Rₑ.

4- Method according to claim 1, wherein the following is chosen:
θₑ/Rₑ≧Sᵣ/Rᵣ

5- Method according to one of claims 1 to 4, wherein the beacon signal transmitted includes a parameter used to identify a station equipped with the transmission antenna.

6- Method according to one of claims 1 to 5, wherein the transmission and reception antenna(s) are separate and their beams pointed mechanically.

7- Method according to claim 6, wherein the beams are rotated alternately in the forward direction and in the backward direction.

8- Method according to one of claims 1 to 5, wherein the transmission and reception antenna(s) are combined and their beams pointed electronically.

9- Method according to one of claims 1 to 8, wherein it comprises a sector scanning step, scanning synchronized on a time frame, the synchronization referring to a different pair of angular positions of the reception and transmission antenna beams.

10- Method according to one of claims 1 to 9, wherein it comprises a step to align the transmission antenna beam on the best position determined using the reception antenna.

11- Method according to one of claims 1 to 10, wherein the transmission frequency is greater than 1 GHz, preferably within the 4.4-5 GHz band, or in the 40 GHz band.

12- Method according to one of claims 1 to 10, wherein the data transmission rate lies between 10 and 50 Mbits/s.

13- System to position an antenna with respect to another antenna comprising at least a transmission antenna with an opening beam θₑ associated with a rotation speed Rₑ, to cover an angular sector Sₑ, the transmission antenna transmitting a signal every T_{b} seconds and a reception antenna with an opening beam θᵣ associated with a rotation speed Rᵣ to cover an angular sector Sᵣ, said antennas being linked with a device designed to vary the beam rotation speeds, wherein it comprises at least:
a device connected to the transmission antenna and designed to generate a transmission signal,
a device designed to acquire the various signals received by the reception antenna and to process the data to deduce the optimum positioning coordinates of the two antennas with respect to each other,
a device to manage the rotation speed parameters of the beams, such that:
θᵣ/Rᵣ≧T_{b},
θₑ/Rₑ≧T_{b},
Rᵣ is greater than Rₑ or Rₑ is greater than Rᵣ.

14- System according to claim 13, wherein the transmission and reception antennas are connected to mechanical means used to point the beams.

15- System according to claim 13, wherein the transmission and reception antennas are electronically-scanned antennas and wherein it comprises a device to point the beams electronically.

16- System according to claim 13, wherein the transmission and reception antennas are located in the same station and wherein it comprises a device to align the two antennas.
